(19) United States
(12) Patent Application Publication
(10) Pub. No.: US 2007/0132941 A1
(43) Pub. Date: Jun. 14, 2007

(54) METHOD FOR SECURING TWO PARTS OF EYEGLASSES

(75) Inventor: Hung Hung, Hong Kong (HK)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: OKIA OPTICAL CO., LTD., Hongkong (HK)

(21) Appl. No.: 11/608,251

(22) Filed: Dec. 8, 2006

Related U.S. Application Data
(60) Provisional application No. 60/748,604, filed on Dec. 9, 2005.

(30) Foreign Application Priority Data
Sep. 11, 2006 (CN) 200620138917.9

(51) Int. Cl. G02C 5/00

(52) U.S. Cl. 351/41

(57) ABSTRACT

A method for securing a first member (30) to a second member (20) of eyeglasses, the method comprising: removing a first portion from the first member (30) to form a cut-out portion (31) on the first member (30); inserting the first member (30) into the second member (20) such that at least the cut-out portion (31) is covered by the second member (20); and applying an external force on the second member (20) to cause the second member (20) to deform against the first member (30) where a portion of the second member (20) is deformed into the cut-out portion (31) to mechanically secure the first member (30) to the second member (20).

### CROSS REFERENCE TO RELATED APPLICATION

This application claims priority to U.S. Provisional Application No. 60/748,604, filed Dec. 9, 2005 and Chinese Utility Model Application No. 200620138917.9, filed Sep. 11, 2006, the contents of which are hereby incorporated by reference.

### TECHNICAL FIELD

The invention concerns a method for mechanically securing a first member to a second member of eyeglasses.

### BACKGROUND OF THE INVENTION

Eyeglasses are an important product for many people who do not possess perfect eyesight and people who wear sunglasses. Due to the large eyeglasses market, manufacturers have conducted research and development to develop new designs to meet market demand and fashion trends. One area of development has been to use the state-of-the-art materials to improve the durability and value of the product.

For example, there is a method for joining different kinds of metals that is disclosed in Chinese patent application number 99109185.X. Although the method can join two unweldable members to each other by magnetism, the degree of firmness and strength of the join is not satisfactory. Transitional welding may solve the problem of welding two metals which are unweldable to each other, i.e. by using a third metal. The third metal is welded with the other two metals by placing it between them. Although, transitional welding achieves a high degree of firmness and strength, it is a complicated process which results in high manufacturing costs. Furthermore, transitional welding does not produce an aesthetically pleasing result for eyeglasses. There are also other joining methods such as outer knurling or flattening. Similarly, these methods do not produce an aesthetically pleasing result for eyeglasses.

Unweldable eyeglasses members refer to metal members which cannot be welded using existing technology for eyeglasses. Such metal members are made of nickel-titanium alloy, magnesium alloy, and aluminum alloy as currently used in eyeglasses. If nickel-titanium alloy members of eyeglasses are to be welded, the existing technique is to form a layer of metal such as nickel or palladium (which has good welding capability) on the surface of the nickel-titanium alloy, and then performing the welding. However, this technique is costly and complicated to manufacture and is time consuming to produce.

Accordingly, there is a desire to connect unweldable members for eyeglasses that produces a high degree of firmness and strength, and is also relatively easy to manufacture and is therefore inexpensive to manufacture.

### SUMMARY OF THE INVENTION

In a first preferred aspect, there is provided a method for securing a first member to a second member of eyeglasses, the method comprising:
removing a first portion from the first member to form a cut-out portion on the first member;
inserting the first member into the second member such that at least the cut-out portion is covered by the second member; and
applying an external force on the second member to cause the second member to deform against the first member where a portion of the second member is deformed into the cut-out portion to mechanically secure the first member to the second member.

The method may further comprise cleaning and polishing an area located where the first member is mechanically secured to the second member.

The first member may be elongate such as a bridge, top bar, rimwire, temple or hinge of eyeglasses.

The second member may be a hollow sleeve.

The first portion may be removed from the first member by milling.

The cut-out portion may be in the form of a slot, recess, or annular groove extending circumferentially around the first member.

The method may further comprise removing a second portion from the first member to form a second cut-out portion on the first member, where the external force is applied to also cause the second member to deform against the first member where another portion of the second member is deformed into the second cut-out portion.

The first and second portions may be removed at the same side in the same plane from the first member.

The second portion may be removed at an opposite side relative to the cut-out portion from the first member.

Te external force may be any one from the group consisting of: stamping, clamping, punching or thrusting.

The first member may be made of a material that is non-solderable or non-weldable.

In a second aspect, there is provided eyeglasses comprising:
a first member having a cut-out portion by removing a first portion from the first member; and
a second member having the first member inserted into it such that at least the cut-out portion is covered by the second member;
wherein an external force is applied on the second member to cause the second member to deform against the first member where a portion of the second member is deformed into the cut-out portion to mechanically secure the first member to the second member.

In a third aspect, there is provided a method for securing a first member to a second member of eyeglasses, the method comprising:
inserting at least an inserted portion of the first member into the second member;
removing a second portion on the second member to form a cut-out portion that extends through the second member and into the inserted portion of the first member;
welding the first member to the second member proximal to the cut-out portion.

A solderable or weldable media may be inserted into the cut-out portion to assist with securing the first member to the second member.

The solderable or weldable media may be copper foil.

In a fourth aspect, there is provided a method for securing a first hollow member to a second member of eyeglasses, the method comprising:
sliding the first hollow member over the second member, the second member having an enlarged portion at a first distal end of the second member;
applying an external force to the first hollow member in a direction parallel to the longitudinal axis of the second member towards the enlarged portion to cause the enlarged portion to deform against the first hollow member to mechanically secure the first hollow member to the second member.

The method may further comprise:
sliding another first hollow member over the second member;
enlarging the second member at a second distal end to create another enlarged portion;
applying an external force to the another first hollow member in a direction parallel to the longitudinal axis of the second member towards the another enlarged portion to cause the another enlarged portion to deform against the another first hollow member to mechanically secure the another first hollow member to the second member.

The method may further comprise deforming the second member into a predetermined shape by applying an external force on the second member.

In a fifth aspect, there is provided a device for securement to eyeglasses, the device comprising:
a first hollow member;
a second member having an enlarged portion at a first distal end of the second member;
wherein an external force is applied to the first hollow member in a direction parallel to the longitudinal axis of the second member towards the enlarged portion to cause the enlarged portion to deform against the first hollow member to mechanically secure the first hollow member to the second member.

The enlarged portion may be formed by flaring or flattening the first distal end of the second member.

The enlarged portion may be formed by expanding the first distal end of the second member transversely outwardly or by expanding the first distal end of the second member towards the circumferential edge of the second member.

If the first distal end of the second member is expanded transversely outwardly, the enlarged portion may be formed in the shape of a sector which deforms against the inner wall of the first hollow member for securement.

If the first distal end of the second member is expanded towards the circumferential edge of the second member, the enlarged portion may be formed in the shape of a trumpet towards the circumferential edge of the second member, where the larger open end of the trumpet deforms against the inner wall of the first hollow member for securement.

In a sixth aspect, there is provided a device for securement to eyeglasses, the device comprising:
a first member having a cut-out portion;
a second hollow member; and
wherein at least the cut-out portion of the first member is inserted into the second hollow member and the second hollow member is deformed against the first member by applying an external force on the second hollow member such that a portion of the second hollow member is deformed into the cut-out portion to mechanically secure the first member to the second hollow member.

In a seventh aspect, there is provided a device for securement to eyeglasses, the device comprising:
a first hollow member for sliding over the second member, the second member having an enlarged portion at a first distal end of the second member;
wherein an external force is applied to the first hollow member in a direction parallel to the longitudinal axis of the second member towards the enlarged portion to cause the enlarged portion to deform against the first hollow member to mechanically secure the first hollow member to the second member.

### BRIEF DESCRIPTION OF THE DRAWINGS

An example of the invention will now be described with reference to the accompanying drawings, in which:

FIG. 1 is a perspective plan view of a first member secured to a second member in accordance with a first embodiment of the present invention;

FIG. 2 is a perspective plan view of a first kind of first member of FIG. 1;

FIG. 3 is a perspective plan view of a second kind of first member of FIG. 1

FIG. 4 is a side view of a third kind of first member of FIG. 1;

FIG. 5 is a side view of a fourth kind of first member of FIG. 1;

FIG. 6 is a perspective plan view of a fifth kind of first member of FIG. 1;

FIG. 7 is a side view of external force being applied on the second member against the first kind of first member of FIG. 2;

FIG. 8 is a side view of external force being applied on the second member against the third or fifth kind of first member of FIG. 4 or 6;

FIGS. 9(a) to (c) are a series of images illustrating the insertion of a first member into a second member;

FIG. 10 is a perspective sectional view of a first member secured to a second member in accordance with a second embodiment of the present invention;

FIG. 11 is a side view of a first member secured to a second member with an extra solderable media inserted into a slot formed through the first and second members;

FIG. 12 is a side view of a first member secured to a second member without an extra solderable media;

FIG. 13 is a side sectional view of a first member secured to a second member in accordance with a third embodiment of the present invention;

FIG. 14 is a side sectional view and cross-sectional view of a first member secured to a second member of FIG. 13; and

FIG. 15 are a series of images illustrating the insertion and securement of a first member to a second member of FIG. 13.

### DETAILED DESCRIPTION OF THE DRAWINGS

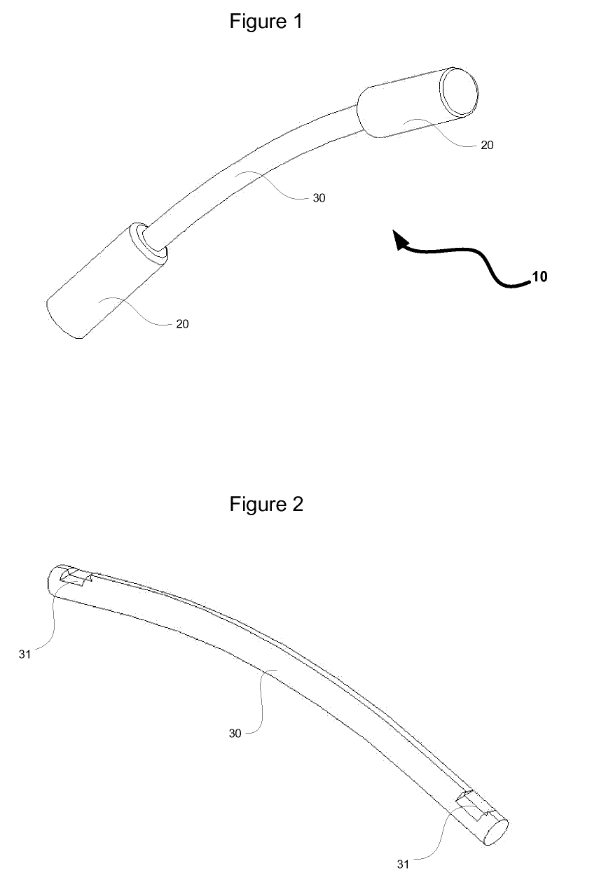

Referring to FIGS. 1 to 8, a method for securing a first member 30 to a second member 20 of eyeglasses is provided. The device 10 comprising the first member 30 secured to the second member 20 produced by the method is depicted in FIG. 1. The method comprises removing a first portion from the first member 30 to form a cut-out portion 31 on the first member 30. Next, the first member 30 is inserted into the second member 20 such that at least the cut-out portion 31 is covered by the second member 20. Then, an external force is applied on the second member 20 to cause the second member 20 to deform against the first member 30 where a portion of the second member 20 is deformed into the cut-out portion 31 to mechanically secure the first member 30 to the second member 20. The first and second members 30, 20 are typically solid metal pieces.

The second member is an extra media 20 that is required to join those eyeglasses parts together which are not soldered or not welded together. The parts which are not soldered or not welded together are the first members 30. The second members are hollow sleeves 20 are used to connect the non-solderable or non-weldable parts 30 by securely attaching the sleeves 20 to the non-solderable or non-weldable parts 30. The non-solderable or non-weldable parts are made of materials such as Nickel Titanium memory alloy or magnesium aluminum alloys. A precise and rigid method is provided. The slot(s) 31 hold the sleeve 20 tightly to the non-solderable or non-weldable parts 30. The sleeve 20 surrounds a portion of the non-solderable or non-weldable parts 30 when the end of the bridge 30 or temple 30 is inserted into the sleeve 20. Next, an external force is applied to secure the sleeve 20 to the end of the bridge 30 or temple 30. An area located where the first member 30 is mechanically secured to the sleeve 20 is cleaned and polished to produce an aesthetically pleasing result.

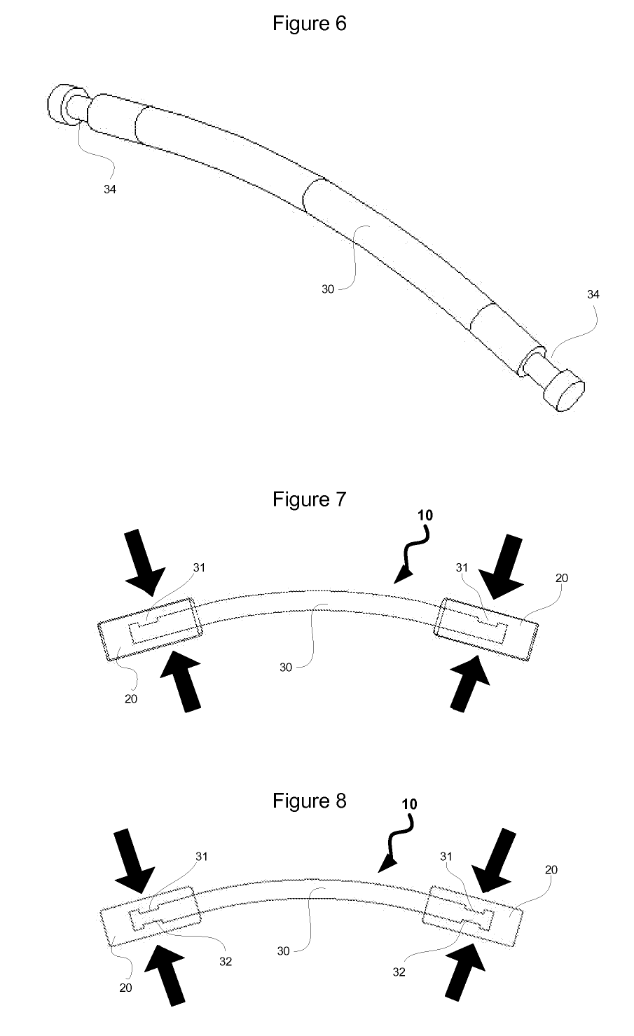

The first member 30 is elongate such as a bridge, top bar, rimwire, temple or hinge of eyeglasses 10. The method typically connects the sleeve 20 to the bridge 30 or temple 30 securely and tightly, and prevents the sleeve 20 from rotating axially. Also, the method enables securement in a specific direction or radial angle. The first portion is removed from the first member 30 by milling. The cut-out portion 31 is in the form of a slot or recess. Referring to FIG. 6, the cut-out portion 31 may also be annular groove 34 extending circumferentially around the first member 30. The external force is any one from the group consisting of: stamping, clamping, punching or thrusting. The external force must be sufficient to deform the sleeve 20 onto the end of the bridge 30 or temple 30. This creates a secure join that is performed mechanically and without requiring soldering or welding the sleeve 20 to the bridge 30 or temple 30.

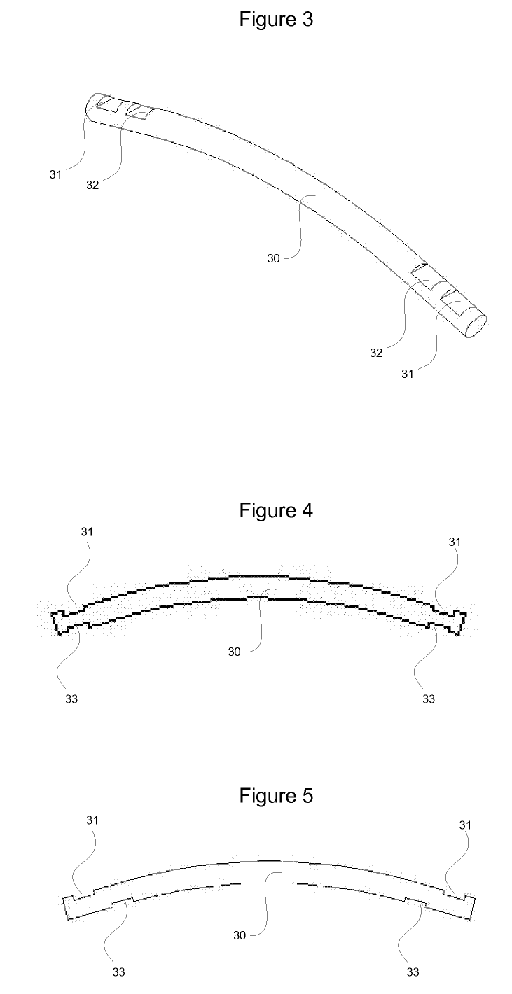

In another embodiment, a second portion is removed from the first member 30 to form a second cut-out portion 32 on the first member 30, where the external force is applied to also cause the sleeve 20 to deform against the first member 30 where another portion of the sleeve 20 is deformed into the second cut-out portion 32. In one scenario, the first and second portions 31, 32 are removed at the same side in the same plane from the first member 30 as depicted in FIG. 3. In another scenario, the second portion is removed at an opposite side relative to the cut-out portion 31 from the first member 30 to form the second cut-out portion 33 as depicted in FIGS. 4 and 5. Having a second cut-out portion 32, 33 or multiple cut-out portions enhances the securement of the first member 30 to the sleeve 20 in increase the frictional area and bonding surfaces.

Referring to FIGS. 7 and 8, the application of the external force is illustrated, For example, the external force may be a clamping force in the direction of the arrows. The external force is applied on the sleeve 20 to cause the sleeve 20 to deform into the slot 31 and against the first member 30. Once deformation of the sleeve 20 has completed, the sleeve 20 is mechanically secured to the first member 30.

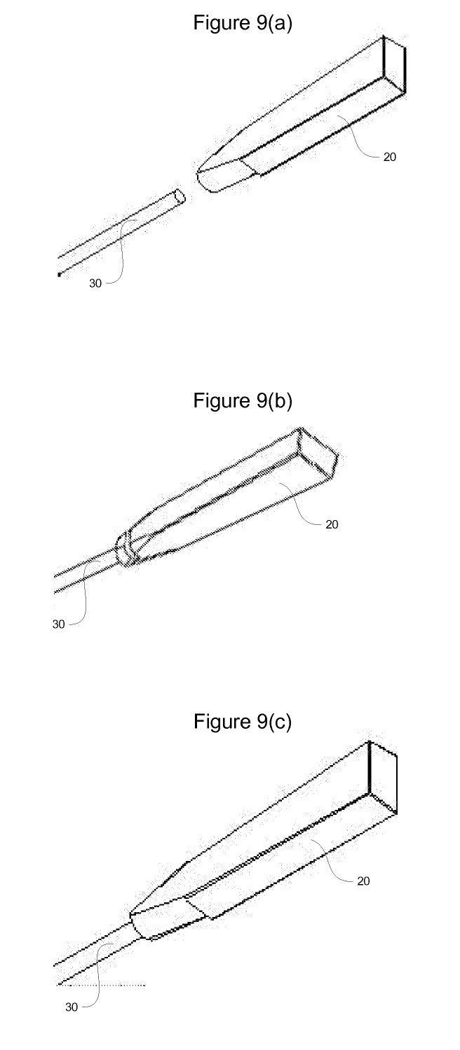

Referring to FIGS. 9 to 12, another embodiment for securing the bridge 30 or temple 30 to the sleeve 20 is illustrated. Again, the bridge 30 or temple 30 is made of a material that is non-solderable and non-weldable. The end of the bridge 30 or temple 30 is initially inserted into the sleeve 20. Next, the sleeve 20 is milled with one or more slots 40. The milling process also mills slightly into the bridge 30 or temple 30. Thus, the slot 40 extends through the sleeve 20 and partially into the bridge 30 or temple 30.

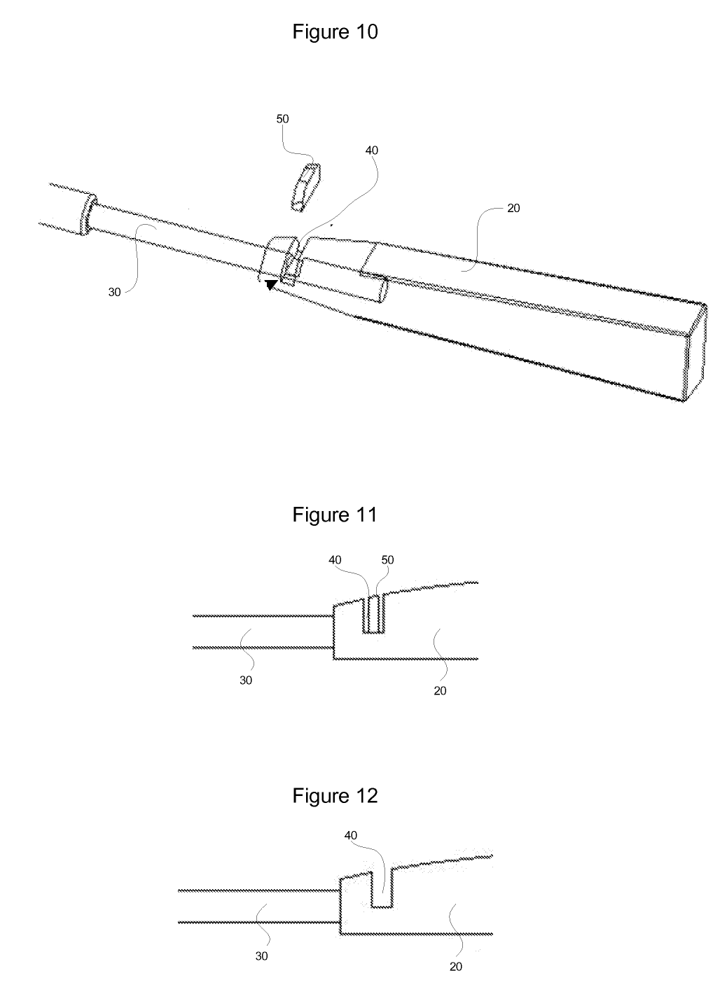

In one scenario, a soldering process is then applied in the area of the slot 40 to join the bridge 30 or temple 30 to the sleeve 20. An extra solderable media 50 may be inserted into the slot 40 to assist with joining the bridge 30 or temple 30 to the sleeve 20 as depicted in FIGS. 10 or 11. For example, the extra solderable media may be copper foil 50. However, this is not mandatory in all scenarios as depicted in FIG. 12. In another scenario, a rigid piece is inserted in the slot 40 which prevents relative movement between the sleeve 20 and bridge 30 or temple 30. The rigid piece is then welded to the sleeve 20 to secure it in place.

After the bridge 30 or temple 30 is secured to the sleeve 20, the area around the join area is cleaned and polished so that the join is not visibly detectable to the eye.

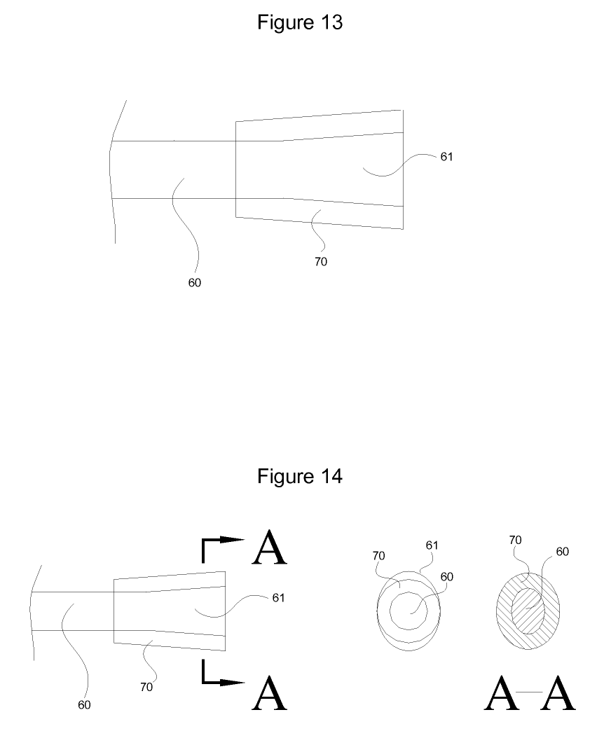

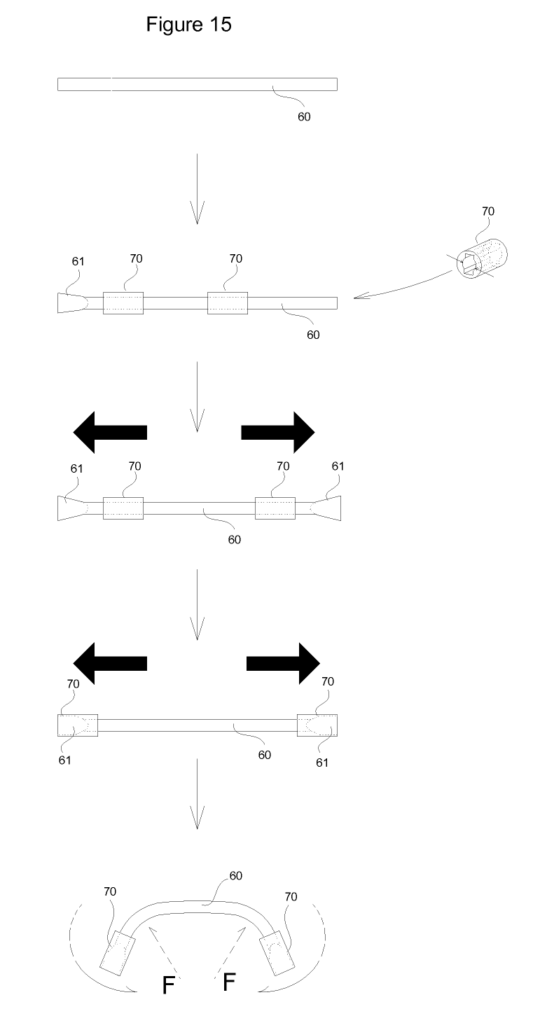

Referring to FIGS. 13 to 15, yet another embodiment for securing a bridge 60 or temple 60 to a hollow sleeve 70 is illustrated. Again, the bridge 60 or temple 60 is made of a material that is non-solderable and non-weldable. One difference with the other embodiments is that an end portion 61 of the bridge 60 or temple 60 must be enlarged relative to the rest of the bridge 60 or temple 60. This first enlarged end portion 61 is also deformable. The enlarged end portion 61 may be formed by flaring or flattening the end portion of the bridge 60 or temple 60, or any other suitable technique. Two sleeves 70 are inserted and slid over the bridge 60 or temple 60. Next, the opposing end of the bridge 60 or temple 60 is enlarged to form a second enlarged end portion 61. Now with both ends of the bridge 60 or temple 60 are enlarged, the two sleeves 70 are pulled outwardly towards the enlarged end portions 61. Applying an external force on the sleeve 70 against the enlarged end portion 61 causes the enlarged end portion 61 to deform. The deformation of the enlarged end portion 61 mechanically secures the sleeves 70 to the bridge 60 or temple 60 without welding or soldering. Later, the second member bridge 60 or temple 60 may be deformed into a predetermined shape by applying an external force on the bridge 60 or temple 60.

Turning to FIG. 14, the first cross section shows the sleeve 70 on the bridge 60 or temple 60 with the enlarged end portion 61. The second cross section along the line A-A shows the result after deformation. The enlarged end portion 61 is deformed and only the sleeve 70 and bridge 60 or temple 60 are discernible in the cross sectional view.

Advantageously, the methods and devices described enable pieces made of a non-solderable and non-weldable material to be used in eyeglasses. Use of such materials may improve the durability and value of the product, and also produce aesthetically pleasing results. A firm, strong and secure bond is able to be achieved between non-solderable and non-weldable pieces and other pieces of eyeglasses using the methods and devices described.

Although it has been described that the cut-out portions are formed by removing portions from the members, it is envisaged that the cut-out portions may be formed during the molding and casting manufacturing process of the members.

Although a slot or recess has been described for the cut-out portion for the first embodiment, it is envisaged that the void may be of any shape, form or dimension so that when the second member 20 is deformed against the first member 30, part of the second member 20 at least partially fills the void.

Although a slot or recess has been described for the cut-out portion for the second embodiment, it is envisaged that the void may be of any shape, form or dimension so long as it passes through the second member 20 and partially into the first member 30 to allow welding to occur in this area.

The terms unweldable, unsolderable, non-weldable and non-solderable refer to pieces or parts of eyeglasses which are not joined to another part by welding or soldering for reasons outlined in the Background of the Invention.

It will be appreciated by persons skilled in the art that numerous variations and/or modifications may be made to the invention as shown in the specific embodiments without departing from the scope or spirit of the invention as broadly described. The present embodiments are, therefore, to be considered in all respects illustrative and not restrictive.

We claim:

1. A method for securing a first member to a second member of eyeglasses, the method comprising:
removing a first portion from the first member to form a cut-out portion on the first member;
inserting the first member into the second member such that at least the cut-out portion is covered by the second member; and
applying an external force on the second member to cause the second member to deform against the first member where a portion of the second member is deformed into the cut-out portion to mechanically secure the first member to the second member.

2. The method according to claim 1, further comprising cleaning and polishing an area located where the first member is mechanically secured to the second member.

3. The method according to claim 1, wherein the first member is elongate such as a bridge, top bar, rimwire, temple or hinge of eyeglasses.

4. The method according to claim 1, wherein the second member is a hollow sleeve.

5. The method according to claim 1, wherein the first portion is removed from the first member by milling.

6. The method according to claim 1, wherein the cut-out portion is in the form of a slot, recess, or annular groove extending circumferentially around the first member.

7. The method according to claim 1, further comprising removing a second portion from the first member to form a second cut-out portion on the first member, where the external force is applied to also cause the second member to deform against the first member where another portion of the second member is deformed into the second cut-out portion.

8. The method according to claim 7, wherein the first and second portions are removed at the same side in the same plane from the first member.

9. The method according to claim 7, wherein the second portion is removed at an opposite side relative to the cut-out portion from the first member.

10. The method according to claim 1, wherein the external force is any one from the group consisting of: stamping, clamping, punching or thrusting.

11. The method according to claim 1, wherein the first member is made of a material that is non-solderable or non-weldable.

12. Eyeglasses comprising:
a first member having a cut-out portion by removing a first portion from the first member; and
a second member having the first member inserted into it such that at least the cut-out portion is covered by the second member;
wherein an external force is applied on the second member to cause the second member to deform against the first member where a portion of the second member is deformed into the cut-out portion to mechanically secure the first member to the second member.

13. Eyeglasses according to claim 12, wherein the first member is elongate such as a bridge, rimwire, temple or hinge of eyeglasses.

14. Eyeglasses according to claim 12, wherein the second member is a hollow sleeve.

15. Eyeglasses according to claim 12, wherein the cut-out portion is in the form of a slot, recess, or annular groove extending circumferentially around the first member.

16. Eyeglasses according to claim 12, further comprising a second cut-out portion by removing a second portion from the first member, where the external force is applied to also cause the second member to deform against the first member where another portion of the second member is deformed into the second cut-out portion.

17. Eyeglasses according to claim 16, wherein the first and second portions are removed at the same side in the same plane from the first member.

18. Eyeglasses according to claim 16, wherein the second portion is removed at an opposite side relative to the cut-out portion from the first member.

19. Eyeglasses according to claim 12, wherein the first member is made of a material that is non-solderable or non-weldable.

20. A method for securing a first member to a second member of eyeglasses, the method comprising:
inserting at least an inserted portion of the first member into the second member;
removing a second portion on the second member to form a cut-out portion that extends through the second member and into the inserted portion of the first member;
welding the first member to the second member proximal to the cut-out portion.

21. The method according to claim 20, wherein a solderable or weldable media is inserted into the cut-out portion to assist with securing the first member to the second member.

22. The method according to claim 21, wherein the solderable or weldable media is copper foil.

23. The method according to claim 20, wherein the first member is made of a material that is non-solderable or non-weldable.

24. A method for securing a first hollow member to a second member of eyeglasses, the method comprising:
sliding the first hollow member over the second member, the second member having an enlarged portion at a first distal end of the second member;
applying an external force to the first hollow member in a direction parallel to the longitudinal axis of the second member towards the enlarged portion to cause the enlarged portion to deform against the first hollow member to mechanically secure the first hollow member to the second member.

25. The method according to claim 24, further comprising:
sliding another first hollow member over the second member;
enlarging the second member at a second distal end to create another enlarged portion;
applying an external force to the another first hollow member in a direction parallel to the longitudinal axis of the second member towards the another enlarged portion to cause the another enlarged portion to deform against the another first hollow member to mechanically secure the another first hollow member to the second member.

26. The method according to claim 25, further comprising deforming the second member into a predetermined shape by applying an external force on the second member.

27. The method according to claim 24, wherein the second member is made of a material that is non-solderable or non-weldable.

28. A device for securement to eyeglasses, the device comprising:
a first hollow member;
a second member having a enlarged portion at a first distal end of the second member;
wherein an external force is applied to the first hollow member in a direction parallel to the longitudinal axis of the second member towards the enlarged portion to cause the enlarged portion to deform against the first hollow member to mechanically secure the first hollow member to the second member.

29. The device according to claim 28, wherein the enlarged portion is formed by flaring or flattening the first distal end of the second member.

30. The device according to claim 28, wherein the enlarged portion is formed by expanding the first distal end of the second member transversely outwardly or by expanding the first distal end of the second member towards the circumferential edge of the second member.

31. The device according to claim 30, wherein if the first distal end of the second member is expanded transversely outwardly, the flared portion is formed in the shape of a sector which deforms against the inner wall of the first hollow member for securement.

32. The device according to claim 30, wherein if the first distal end of the second member is expanded towards the circumferential edge of the second member, the flared portion is formed in the shape of a trumpet towards the circumferential edge of the second member, where the larger open end of the trumpet deforms against the inner wall of the first hollow member for securement.

33. The device according to claim 29, wherein the second member is made of a material that is non-solderable or non-weldable.

34. A device for securement to eyeglasses, the device comprising:
a first member having a cut-out portion;
a second hollow member; and
wherein at least the cut-out portion of the first member is inserted into the second hollow member and the second hollow member is deformed against the first member by applying an external force on the second hollow member such that a portion of the second hollow member is deformed into the cut-out portion to mechanically secure the first member to the second hollow member.

35. The device according to claim 34, wherein the first member is made of a material that is non-solderable or non-weldable.

36. A device for securement to eyeglasses, the device comprising:
a first hollow member for sliding over the second member, the second member having a flared portion at a first distal end of the second member;
wherein an external force is applied to the first hollow member in a direction parallel to the longitudinal axis of the second member towards the flared portion to cause the flared portion to deform against the first hollow member to mechanically secure the first hollow member to the second member.

37. The device according to claim 36, wherein the second member is made of a material that is non-solderable or non-weldable.
